(19) United States
(12) Patent Application Publication
(10) Pub. No.: US 2010/0039823 A1
(43) Pub. Date: Feb. 18, 2010

(54) LIGHT SOURCE DEVICE AND PROJECTION DEVICE UTILIZING THE SAME

(75) Inventors: MING-CHIH SUN, Tu-Cheng (TW); KAI HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/340,749

(22) Filed: Dec. 22, 2008

(30) Foreign Application Priority Data
Aug. 18, 2008 (CN) 200810303936.6

(51) Int. Cl. F21V 7/00

(52) U.S. Cl. 362/296.08

(57) ABSTRACT

A light source device for a projection device includes a lamp and a reflector. The lamp includes a light emitter and two electrode arms. The light emitter emits light, and the two electrode arms include reflective coatings, and are integrally formed with the light emitter. The reflector retains the lamp and includes a curved reflective inner surface in a parabolic shape.

### BACKGROUND

1. Technical Field

The disclosure relates to projection devices and, particularly, to a light source device capable of resisting overheating and a projection device utilizing the same.

2. Description of the Related Art

In general, light source devices used in projectors include a lamp received in a reflector. When the lamp emits light, a portion of the light is reflected back to the lamp via the reflector, heating the lamp and thus shortening the service life thereof.

Therefore, it is desirable to provide a light source device and a projection device utilizing the same which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the light source device and the projection device. Moreover, in the drawings, like reference numerals designate corresponding parts throughout the several views.

FIG. 1 is an isometric view showing a configuration of a light source device according to an embodiment of the disclosure.

FIG. 2 is a cross section view taken along the line II-II of FIG. 1.

FIG. 3 is a cross section view of a light source device according to an embodiment of the disclosure.

FIG. 4 is an isometric, partially cutaway view of a projection device utilizing the light source device of FIG. 1, according to an embodiment of the disclosure.

### DETAILED DESCRIPTION OF THE EMBODIMENTS

Embodiments of the light source device and projection device utilizing the same are described in detail here with reference to the drawings.

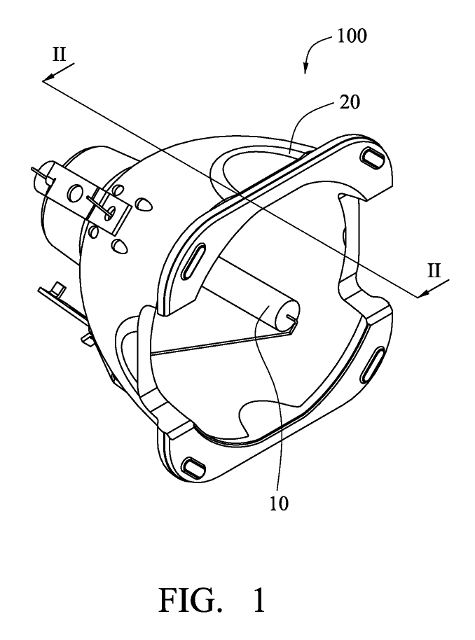

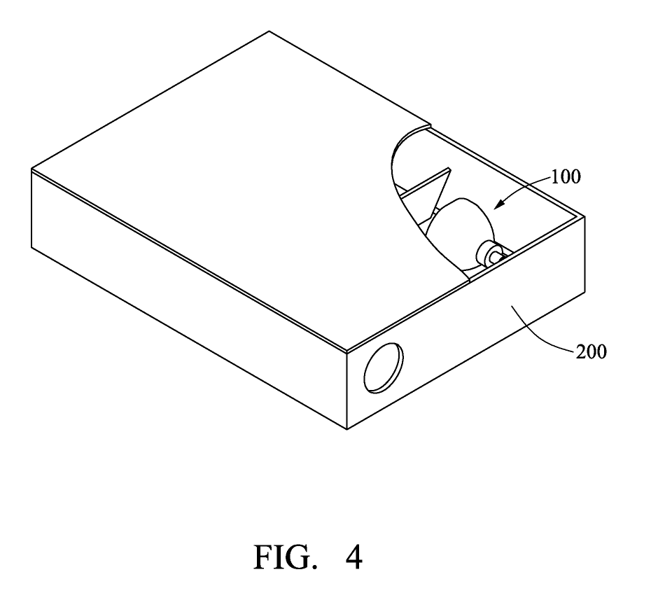

As shown in FIG. 1, a light source device 100 of a first embodiment can be applied to a projection device 200 (see FIG. 4) and includes a lamp 10 and a reflector 20.

A configuration of the lamp 10 and the reflector 20 is detailed as follows.

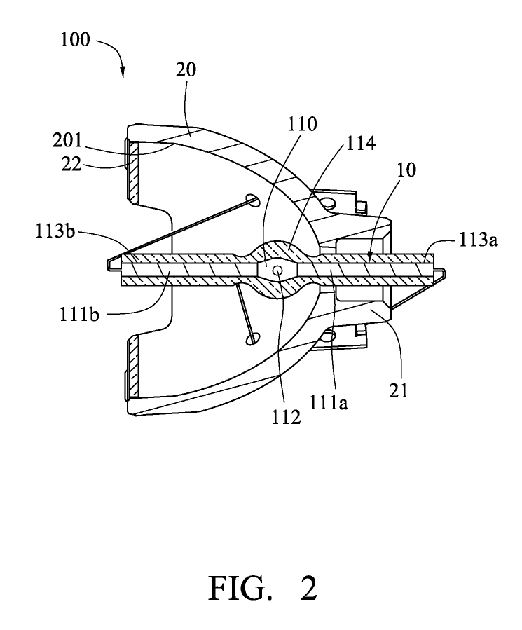

As shown in FIG. 2, the lamp 10 includes a light emitter 110, two electrode arms 111a, 111b electrically coupled to front and rear sides of the light emitter 110 respectively. The light emitter 110 emits light when voltage is applied to the two electrode arms 111a, 111b.

The light emitter 110 includes an enclosure receiving portion 112. The enclosure receiving portion 112 is made of transparent material such as silica glass and is configured for receiving light-emitting material. Examples of the light-emitting material enclosed in the enclosure receiving portion 112 are noble gases such as neon, argon, krypton, and xenon, and xenon, mercury, and a metallic halogen compound.

The electrode arms 111a, 111b can be integrally formed with the light emitter 110 in a manner that each of them extends outwardly from the light emitter 110. Each of the electrode arms 111a, 111b includes a reflective coating 113a and 113b, respectively. The reflective coatings 113a, 113b can be a dielectric multilayer film that can reflect light.

The lamp 10 also includes an enclosure 114 surrounding the light emitter 110 and the electrode arms 111a, 111b, providing protection from damage. The enclosure 114 can be a layer of transparent glass or transparent plastic through which light from light emitter 110 passes.

The reflector 20 includes a curved reflective inner surface 201, which can be, for example, parabolic, and directs light from the light emitter 110 along a light path. The curved reflective inner surface 201 is a dielectric multilayer film that reflects light. The reflector 20 also includes a connection portion 21 and a transparent cover 22. The connection portion 21 encloses the electrode arm 111a and is secured to a fixed part of the projection device 200 such as a light source fixture. The transparent cover 22 covers the opening of the reflector 20, protecting elements therein such as the lamp 10 from damage and providing a light transmission pathway.

The electrode arms 111a, 111b coated with reflective coatings 113a, 113b reflect light reflected from the reflector 20, reducing heat absorption thereof and avoiding overheating of electrode arms 111a, 111b. As a result, service time of the lamp 10 can be prolonged.

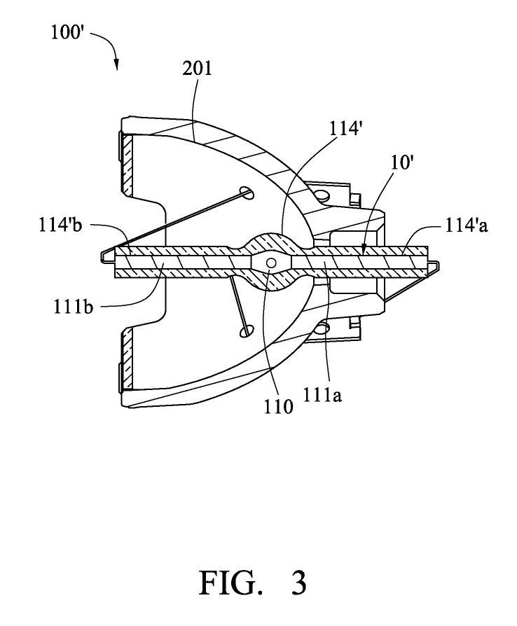

In FIG. 3, a light source device 100′ of a second embodiment is shown, differing from the light source device 100 only in the inclusion of a lamp 10′.

The lamp 10′ includes an enclosure 114′ enclosing the light emitter 110 and the two electrode arms 111a, 111b, and including reflective coatings 114′a, 114′b formed on the enclosure 114′ shielding corresponding to the electrode arms 111a, 111b from light. The reflective coatings 114′a, 114′b are dielectric multilayer films that reflect light.

The enclosure 114′ coated with reflective coatings 114′a, 114′b shielding corresponding to the electrode arms 111a, 111b reflects light reflected from the reflector 20, reducing heat absorption thereof and avoiding overheating the electrode arms 111a, 111b. As a result, service time of the lamp 10 can be prolonged.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light source device, comprising:
a lamp comprising a light emitter and two electrode arms, the two electrode arms comprising reflective coatings and being integrally formed with the light emitter such that each extends outwardly from the light emitter; and
a reflector receiving the lamp therein, and comprising a curved reflective inner surface in a parabolic shape.

2. The light source device of claim 1, wherein the light emitter has a configuration in which a light-emitting material is enclosed in an enclosure receiving portion located in the light emitter; the enclosure receiving portion being made of silica glass.

3. The light source device of claim 2, wherein the material enclosed in the enclosure receiving portion is a noble gas.

4. The light source device of claim 1, wherein the reflective coatings are dielectric multilayer films.

5. The light source device of claim 1, wherein the lamp further comprises an enclosure protecting the light emitter and the two electrode arms.

6. The light source device of claim 5, wherein the enclosure is made of a transparent glass or transparent plastic.

7. The light source device of claim 1, wherein the reflector further comprises a connection portion and a transparent cover, the connection portion enclosing one of the two electrode arms and capable of being secured to a part of the projection device, the transparent cover covering the lamp and providing a light transmission pathway.

8. The light source device of claim 1, wherein the curved reflective inner surface is coated with a dielectric multilayer film.

9. A light source device, comprising:
a lamp comprising a light emitter, two electrode arms and an enclosure retaining the light emitter, the two electrode arms electrically coupled to a front and rear sides of the light emitter, respectively, and the enclosure comprising reflective coatings shielding corresponding to the two electrode arms from light and capable of protecting the light emitter and the two electrode arms; and
a reflector receiving the enclosure and comprising a curved reflective inner surface in a parabolic shape.

10. The light source device of claim 9, wherein the light emitter has a configuration in which a light-emitting material is enclosed inside an enclosure receiving portion made of silica glass.

11. The light source device of claim 10, wherein the material enclosed in the enclosure receiving portion is a noble gas.

12. The light source device of claim 9, wherein each of the reflecting coatings is a dielectric multilayer film.

13. The light source device of claim 9, wherein the enclosure is a transparent glass or transparent plastic.

14. The light source device of claim 9, wherein the reflector further comprises a connection portion and a transparent cover, the connection portion enclosing one of the two electrode arms and capable of being secured to a part of the projection device, the transparent cover covering the lamp in the light source device and providing a light transmission pathway.

15. The light source device of claim 9, wherein the curved reflective inner surface is coated with a dielectric multilayer film.

16. A projection device, comprising:
a lamp comprising a light emitter, two electrode arms and an enclosure, the two electrode arms electrically coupled to a front and rear sides of the light emitter and comprising reflective coatings, the enclosure retaining the light emitter and the two electrode arms and protecting the lamp and the two electrode arms; and
a reflector retaining the enclosure and comprising a connection portion and a transparent cover, the connection portion enclosing one of the two electrode arms and being secured to a part of the projection device, the transparent cover covering the lamp and providing a light transmission pathway.

17. The projection device of claim 16, wherein the light emitter has a configuration in which a light-emitting material is enclosed inside of an enclosure receiving portion made of silica glass.

18. The projection device of claim 17 wherein the material enclosed in the enclosure receiving portion is a noble gas.

19. The projection device of claim 16, wherein each of the reflective coatings is a dielectric multilayer film.

20. The projection device of claim 16, wherein the enclosure is transparent glass or transparent plastic.
